(19) United States
(12) Patent Application Publication
(10) Pub. No.: US 2009/0211892 A1
(43) Pub. Date: Aug. 27, 2009

(54) PYROLYSIS SYSTEM FOR WASTE RUBBER

(75) Inventors: William Frederick Cunningham, Medicine hat (CA); David Schroeder, Clive (CA)

Correspondence Address: Daniel R Polonenko;FASKEN MARTINEAU DUMOULIN, 2100-1075 West Georgia Street, Vancouver, BC, V6E 3G2, CA

(73) Assignee: AFAB FINANCIAL LTD., Calgary, AB (CA)

(21) Appl. No.: 12/083,162

(22) PCT Filed: Oct. 4, 2005
(86) PCT No.: PCT/CA2005/001526

§ 371 Date: Jan. 14, 2009

Related U.S. Application Data
(60) Provisional application No. 60/615,598, filed on Oct. 5, 2004.

(51) Int. Cl. C10B 53/07; C10B 1/02; B01D 5/00; B01D 3/00

(52) U.S. Cl. 201/25; 202/105

(57) ABSTRACT

An apparatus for separating components of batches of waste rubber by pyrolysis comprises at least one heating chamber interconnected with a condenser by a conduit. The heating oven is provided with a plurality of cooperating heating elements, an inlet for receiving waster rubber, and an outlet for egress of pyrolyzed gaseous components. The condenser condenses and separates cooled liquid components from the gaseous components. Separated gaseous components are exhausted from the condenser. Cooled liquid components are conveyed from the condenser to a re-circulation tank. The conduit is provided with a pair of opposed injectors adjacent the outlet of the heating oven. A re-circulation line interconnects the re-circulation tank with the injectors and is provided with a pressurizing device for injecting cooled liquid components through the injectors into the conduit in the form of intersecting liquid laminar sheets thereby applying a vacuum draw on the egressing pyrolyzed gaseous components.

### TECHNICAL FIELD

This invention relates to pyrolysis systems and apparatus. More particularly, the invention relates to pyrolysis systems and apparatus for processing waste rubber.

### BACKGROUND ART

Disposal of used rubber tires is associated with major municipal, industrial, environmental and regulatory concerns worldwide due to: (1) the non-durable nature and relatively rapid wear properties of rubber tires and other such products, (2) the recalcitrance of rubber-based products in terrestrial and aquatic environments, and (3) the technical difficulties and high costs associated with processing scrapped used rubber tires and other forms of waste rubber. In the United States for example, it is estimated that waste tires are generated at an average rate of one tire per capita annually resulting in the production of over 300 million scrapped used tires. This is equivalent to 5.28 million tons of scrapped used tires each year which represents nearly 2% of the total solid waste generated in the USA. About 22% of this annual volume is stockpiled in landfills and requires over 164 million cubic feet of new storage space each year. As another example, the Province of Ontario in Canada generates approximately 14 million scrapped rubber tires annually and is estimated to have over 28 million tires currently stockpiled in open-air holding areas. Current estimates indicate that over 3 billion scrapped tires are stocked piled worldwide and that this volume is increasing by 10% each year.

Due to their high contents of flammable hydrocarbon materials, storage of large quantities of scrapped waste tires is hazardous and dangerous to adjacent communities and ecosystems as evidenced by tire fires in Modesto, Calif., USA in September 1999 which involved 5 million tires and required 30 days to extinguish, in Hagersville, Ontario, Canada in February 1990 which involved 14 million tires and required 17 days to extinguish (however, the site was still smouldering 3 years later), and in Watertown, Wis., USA in July 2005 which involved 1 million tires and took 6 days to extinguish with the help of rain. Waste tire fires are difficult to access due to the large volumes of materials stockpiled, difficult to extinguish to their contents of flammable hydrocarbon material and therefore tend to burn for extended periods of time generating excessive amounts of air and water pollution caused by the release of toxic chemicals and noxious smoke. Consequently, increasingly stringent municipal, regional and federal regulations are being promulgated and imposed on the transport, storage and processing of scrapped rubber tires and forms of waste rubber materials. As a result, many landfills in North America and elsewhere are now refusing to accept scrapped tires and rubber waste.

Considerable efforts have been expended on finding alternative methods to processing and recycling scrapped used tires and other forms of waste rubber. Whole tires have been used for stabilization of severely sloping landscapes e.g., adjacent to roadways. Processes such as shredding, chipping, cutting, crumbing, granulating and pulverizing have been developed for disintegrating large bulky waste rubber products into particulate materials, and for incorporation of these particulate materials into synthetic processes for production of rubberized substrates used in road construction, in the manufacturing of parts, components and panels for use in manufacturing of transportation-related equipment, and in industrial and residential constriction.

Another promising alternative for disposing of waste rubber products including used tires, is the use of pyrolysis. Pyrolysis is generally defined as a chemical degradation/decomposition reaction of organic materials that is caused by the application of thermal energy in an inert environment. In the context of waste rubber processing, pyrolysis is the thermal decomposition of rubber in the absence of oxygen at temperatures in the range of 600° C.-800° C. and higher. While in practice it is not possible to achieve a completely oxygen-free environment thereby resulting in some oxidation occurring, such oxidation is generally nominal. Through pyrolysis, organic materials such as rubber are transformed into gases such as methane, small quantities of liquids, and a solid carbon-containing residue commonly referred to as “coke” or “carbon black”.

It is known in the prior art to employ pyrolysis methods for decomposition and transformation of organic compounds such as waste rubber. For example, U.S. Pat. No. 5,894,012 teaches a pyrolysis method and a system for recovering oil and carbon black from waste rubber, but is primarily directed to the post-pyrolysis processing of carbon black derived thereby. U.S. Pat. No. 5,744,668 teaches a pyrolysis process for conversion of waste rubber to produce hydrocarbon oil products and carbon black, and further teaches processes for purifying, catalytic cracking and fractionation of pyrolysis products derived from waste rubber.

The prior art teaches that pyrolysis of waste rubber can be practiced using “batch” systems or “continuous feed” systems. Continuous feed pyrolysis systems are generally considered to be efficient and amenable for high-volume processing of waste rubber. However, continuous feed pyrolysis systems are complex infrastructures that require significant capital expenditures and maintenance. The prior art relating to pyrolysis of waste rubber explicitly or implicitly teaches that “batch” pyrolysis processes are inefficient and undesirable. Regardless of whether batch or continuous feed systems are used, pyrolysis is conducted within ovens provided with openings for loading waste rubber and removing solid pyrolysis by-products. These openings are accessible through removable covers. It is essential that no oxygen is allowed to enter the ovens during pyrolysis. Therefore, it is necessary to provide for each opening in a pyrolysis oven, a gasket material which is sealable by tightening the lid to the oven by multiple spaced-apart bolts. The rims of the openings, the lids and the bolts fastening the lids to the rims of openings in pyrolysis ovens described in the prior art, are typically exposed to the high levels of beat generated during pyrolysis resulting in numerous problems. For example, the extreme levels of heat generated during pyrolysis cause expansion and stretching of the bolts as temperatures increase followed by contraction when the oven is cooled. Consequently, the pressure applied to the sealing gasket material is somewhat released as temperatures increase thereby providing egress of oxygen into the oven during pyrolysis. Repeated expansion and contraction of the bolts during multiple pyrolysis operations predisposes the bolts to fail. Furthermore, the extreme levels of heat generated during pyrolysis require the use of expensive complex gasket materials which have relatively short lifetimes and must be frequently replaced. Failure of the seals between the oven openings and their lids during pyrolysis as a result of gasket and/or bolt failures results in the release of noxious and toxic gases and furthermore, could result in explosions and fires. Some of the problems caused by the high temperatures required for pyrolysis of waste rubber at atmospheric pressures can be overcome by applying significant negative pressures in the form of a vacuum draw to the exhaust outlets of pyrolysis reactors. U.S. Pat. No. 4,740,270 teaches that applying a vacuum to a pyrolysis exhaust line after it has passed through a train of condensers in a continuous pyrolysis system can provide complete pyrolytic degradation of waste tire cuttings at temperatures ranging between 360° C.-415° C. Canadian Patent No. 2,045,254 teaches that applying a vacuum to a pyrolysis exhaust line after it has passed through a train of condensers in a continuous pyrolysis system can provide complete pyrolytic degradation of waste tire cuttings at temperatures ranging between 425° C.-650° C.

It is well-known that very fine particulate or powdered forms of solid pyrolysis by-products commonly intermingle with pyrolysis exhaust gases and exit the ovens into exhaust outflow pipes wherein they settle and accumulate thereby restricting the flow of pyrolysis exhaust gases therethrough. The particulate solid by-products also commonly are carried by the exhaust gases by the exhaust outlet piping into separators/condensers wherein they also settle and accumulate and cause blockages during the cooling and separation of pyrolysis by-products in the prior art processing systems. Prior art disclosures, referring by way of example to U.S. Pat. No. 6,736,940, teach that exhaust piping conveying pyrolysis gases to separators/condensers must be as short as possible and furthermore, that it is essential the gases are kept as hot as possible during conveyance from pyrolysis ovens to separators/condensers. Furthermore, prior art disclosures, referring by way of example to U.S. Pat. No. 6,736,940 and published PCT Application No. WO 2004/037949A1, teach the injection of recovered and recycled liquid pyrolysis by-products into separators/condensers to wash away solid particulates of pyrolysis by-products that may have been deposited within the separators/condensers and thereby interfering with the flow of pyrolysis exhaust gases therethrough.

### DISCLOSURE OF THE INVENTION

The exemplary embodiments of the present invention, at least in preferred forms, are directed to the processing of waste rubber for separation and recovery therefrom of gaseous components and liquid components.

According to one aspect of the invention, there is provided an apparatus for separating components from waste rubber comprising a heating oven for receiving and pyrolyzing therein waste rubber thereby producing gaseous components, a conduit adapted for receiving therein the pyrolyzed gaseous components and providing a vacuum draw thereon, a condenser interconnected with the conduit for receiving, cooling and separating therein gaseous and liquid components, a re-circulation tank for receiving therein the cooled liquid components, and a re-circulation line interconnecting the re-circulation tank and the conduit, the re-circulation lime provided with a pressurizing device for spraying cooled liquid components into the conduit.

According to a second aspect of the invention, there is provided an apparatus for separating components from waste rubber wherein the apparatus is equipped with a conduit having one end that is interconnectable with a condenser and the other end that is detachably engagible with an outlet of a pyrolysis heating oven wherethrough pyrolyzed gaseous components egress, wherein the conduit is provided with a pair of opposed injectors communicating therethrough adjacent the detachable end for injecting cooled liquid components therethrough the injectors.

In a preferred form, the opposed injectors are inclined with the direction of flow of pyrolyzed gaseous components through the conduit, and inject cooled liquid components into the conduit in the form of intersecting liquid laminar sheets thereby providing a vacuum draw on the pyrolyzed gaseous components.

According to another aspect of the invention, there is provided an apparatus for separating components from waste rubber wherein the apparatus is equipped with a heating oven provided with a plurality of cooperating heating elements. The heating oven is further provided with an aperture for receiving waste rubber therethrough, wherein the aperture is encircled by an outward extending insulating collar. The oven is further provided with a detachable lid structure for slidingly communicating therewith the insulating collar and sealingly engaging a gasket interposed between the lid structure and the insulating collar. The lid structure is provided with an outlet for egress of pyrolyzed gaseous components therefrom the oven wherein the outlet is engaged with a conduit provided with a pair of opposed injectors for receiving therethrough cooled liquid components.

In a preferred form, the detachable lid structure is provided with a downward extending chamber for sliding communicating with the upward extending collar. The insulating collar and the downward extending chamber of the lid structure are preferably filled with an insulating material. It is preferred that the insulating material is carbonaceous.

According to yet another aspect of this invention, there is provided an apparatus for separating components from waste rubber wherein the apparatus is equipped with a heating oven provided with a plurality of cooperating beating elements. The heating oven is further provided with an aperture for receiving waste rubber therethrough, wherein the aperture is encircled by an outward extending insulating collar. The oven is further provided with a detachable lid structure for slidingly communicating therewith the insulating collar and sealingly engaging a gasket interposed between the lid structure and the insulating collar. The lid structure is provided with an outlet for egress of pyrolyzed gaseous components therefrom the oven wherein the outlet is engaged with a conduit provided with a pair of opposed injectors for receiving therethrough cooled liquid components. The oven is demountable from the lid structure and transportable along a track to a central processing facility wherein waste rubber is loaded into the oven and solid pyrolyzed components are unloaded from the oven.

According to a preferred embodiment, the demountable heating oven is fixed onto a cart for transport along the track.

According to another preferred embodiment, the demountable heating oven is engagible with a transportable crane mechanism suspended from an overhead track.

According to yet another aspect of the invention there is provided a process for separating components of waster rubber comprising:

(a) charging a heating oven with the waste rubber;

(b) pyrolizing the waste rubber in the oven to produce a stream of gaseous components;

(c) passing said stream of gaseous components through two intersecting liquid laminar sheets of injected cooled liquid components thereby providing a vacuum draw on said gaseous components and intermingling said gaseous components with the injected cooled liquid components;

(d) condensing said intermingled gaseous and liquid components to produce and separate cooled gas components and cooled liquid components;

(e) allowing the cooled gas components to egress through an exhaust stack for further processing;

(f) conveying the recovered cooled liquid components to a holding tank; and

(g) re-circulating at least a portion of the recovered cooled liquid components for injection into the stream of gaseous components egressing from said heating oven.

According to a preferred embodiment, the waste rubber comprises scrapped used tires. The tires may be processed whole, or alternatively, may be shredded, chipped, cut, crumbed, granulated or pulverized.

According to another preferred embodiment, the heating oven containing waste rubber is first heated to a temperature selected from the range of 550° C. to 650° C., and maintained at said temperature until a stream of pyrolyzed gaseous components is produced therefrom and egresses from the oven. Cooled liquid components are then continuously injected into the stream of egressing pyrolyzed gaseous components for the duration of the pyrolysis process from a pair opposing injectors, said liquid components maintained at a temperature selected from the range of −20° C. to 55° C. After approximately one third of the waste rubber has been pyrolyzed, the temperature within the oven is reduced to a temperature selected from the range of 500° C. to 549° C. After approximately two thirds of the waste rubber has been pyrolyzed, the temperature within the oven is further reduced to a temperature selected from the range of 450° C. to 499° C. for the duration of the pyrolysis process.

According to yet another preferred embodiment, the cooled liquid components are maintained at a temperature selected from the range of 15° C. to 50° C.

### BRIEF DESCRIPTION OF THE DRAWINGS

The present invention will be described in conjunction with reference to the following drawings in which:

FIG. 1 is a schematic view of a first embodiment of the pyrolysis system according the to present invention;

FIG. 2 is a top plan view of the pyrolysis system shown in FIG. 1;

FIG. 3 is a front elevation view, partially in section, of the pyrolysis system shown in FIG. 1;

FIG. 4 is an end view of the pyrolysis system shown in FIG. 1;

FIG. 5 is a close-up cross-sectional side view of a second embodiment of the pyrolysis system of the present invention;

FIG. 6 is a close-up cross-sectional top plan view of a third embodiment of the pyrolysis system;

FIG. 7 is a partial cross-sectional side view of the pyrolysis system shown in FIG. 1;

FIG. 8 is a partial top plan view of the pyrolysis system shown in FIG. 4a; and

FIG. 9 is a top plan view of a fourth embodiment of the pyrolysis system of the present invention.

### BEST MODES FOR CARRYING OUT THE INVENTION

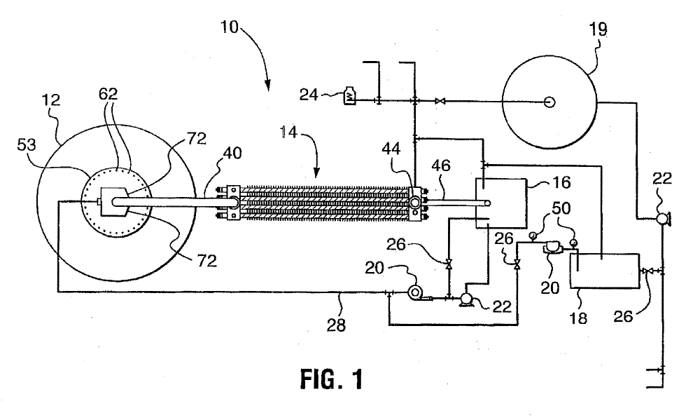

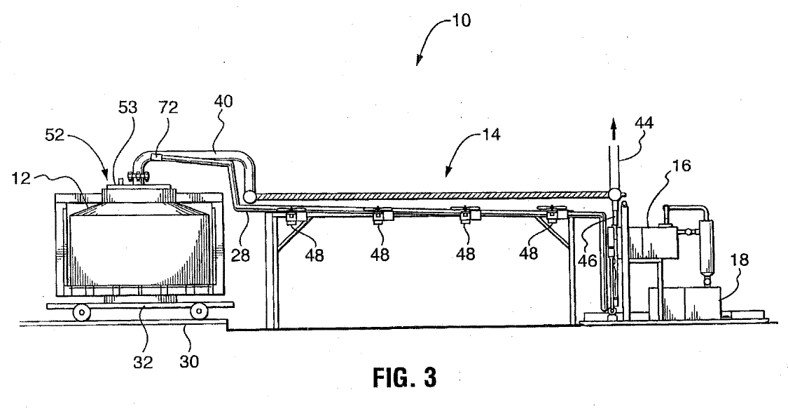

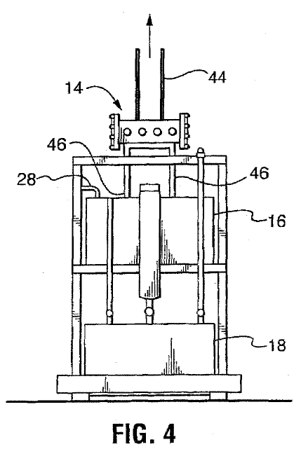

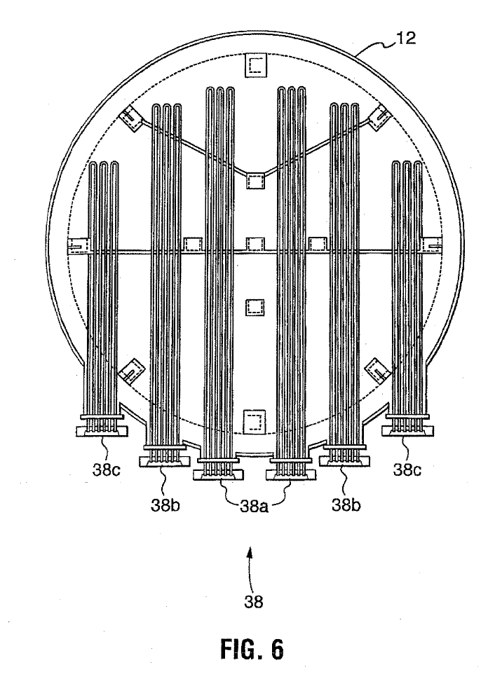

An exemplary embodiment of the rubber processing apparatus is shown in accompanying drawings, and is generally referred to by the numeral 10. As can best be seen in FIGS. 1-4, the apparatus 10 comprises at least one transportable oven 12 having heating elements 38 arranged therein (as can best be seen in FIG. 6), although other heating element arrangements and configurations are possible within the scope of this invention, including diverse possible element numbers, locations and control means). The oven 12 is mountable on an oven cart 32 (as best shown in FIG. 3). Cart 32 is transportable on a track 30 which enables the oven 12 to be moved into a position within a central waste rubber loading area/by-product receiving/holding area in a processing facility where scrapped used tires and other rubber waste can be loaded into the oven, after which the oven 12 is moved by the cart 32 into a position where the oven 12 can be demountably engaged with an oven lid structure 52 for pyrolysis of waste rubber contained therein.

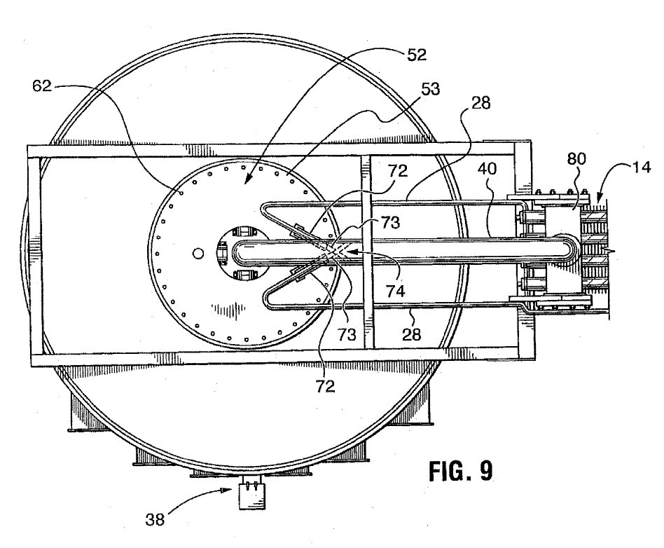

Gaseous pyrolysis by-products are exhausted from oven 12 through exhaust outflow pipe 40 into condenser 14 for separation therein of exhausted pyrolysis by-products into cooled gaseous and liquid by-products. Cooled gaseous pyrolysis by-products are exhausted from condenser 14 via exhaust piping 44 for incineration by incinerator 24 (FIG. 1) or, alternatively, for further refining and processing. Cooled liquid pyrolysis by-products are conveyed from condenser 14 via piping conduit 46 to a recirculation tank 16, from which a portion of the cooled liquid by-products is recirculated by means of pump 22 via injection line 28 to the exhaust outflow pipe 40. Prior to introduction into the outflow pipe 40, the cooled liquid pyrolysis by-products pass through a filter 20 and a valve 26 and are then injected into the outflow pipe 40 via injectors 72 (FIG. 9) extending into exhaust outflow pipe 40.

After pyrolysis of the charge within the oven 12 is complete, the oven is disengaged from lid structure 52 and then moved back by cart 32 to the central waste rubber loading area/by-product receiving/holding area for cooling and removal of the oven contents which are primarily solid by-products such as carbon.

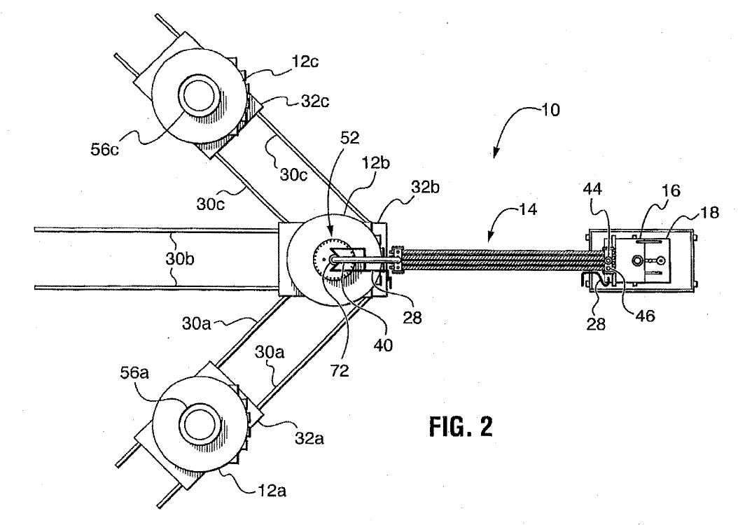

As exemplified in FIG. 2, apparatus 10 can be adapted by providing a plurality of tracks 30 (illustrated as tracks 30a, 30b, and 30c) positioned in a radius around a lid structure 52, thus providing means by which multiple carts and ovens carried thereon (illustrated as 32a and 12a, 32 b and 12b, and 32c and 12c) cooperate with a single lid structure 52 and associated equipment. Though illustrated in the exemplary embodiment set out herein, floor-mounted track 30 and cart 32 are optional features of the apparatus of the present invention, with oven 12 potentially being fixed with respect to the entirety of the apparatus as shown in FIG. 1. Alternatively, oven 12 may be suspended from transportable crane apparatus cooperating with a track mounted above the apparatus with the track extending into the central waste rubber loading area/by-product receiving/holding area. Further to the embodiment exemplified in FIG. 2, a plurality of ovens 12 may each be suspended from a crane apparatus cooperating with one of a plurality of overhead tracks positioned in a radius around a lid structure 52 interconnected with a condenser 14. A preferred method of operation is to provide sufficient ovens 12 to allow the pyrolysis operation to be carried out with minimal delay (a freshly-loaded oven being available as soon as pyrolysis in another oven is complete). It may even be possible to arrange the system so that the operations of pyrolysis, oven-opening, oven-cooling, oven-emptying, oven-filling and oven-transportation are carried out quasi-continuously, or at least with maximum efficiency and minimum delay.

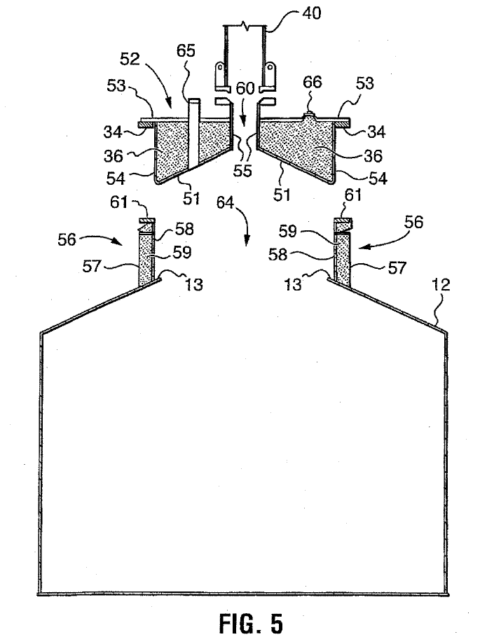

A preferred embodiment of the pyrolysis system of the present invention is illustrated in FIG. 5. The upper portion of oven 12 is provided with an aperture 64 to enable loading of waste rubber into the oven for pyrolysis, and for the removal of pyrolysis by-products. Aperture 64 is covered by and disengagably sealed to the lid 52 during the pyrolysis process. Aperture 64 is encircled with an upwardly extending insulating wall structure 56 that is integrally engaged with the upper portion of oven 12 such that an oven rim portion 13 extends into aperture 64. Wall structure 56 comprises an outer wall 57 integrally joined to a top surface 61 and to an inner wall 58 defining an insulating annular space 59 therein. If so desired, insulating annular space 59 may be filled with an insulating material, such as particulate carbon or other such materials.

Lid 52 comprises a plate 53 provided with a central aperture 60 extending therethrough. An insulating chamber 36 is formed on the bottom surface of plate 53 and comprises a downward extending outer wall 54, a sloping floor portion 51, and an upwardly-extending tubular inner wall 55 sealably attached to plate 53 and aligned with aperture 60. The top portion of tubular inner wall 55 is interconnectable with exhaust outflow pipe 40. It is preferred that outer wall 54 of lid 52 extends downwardly to a further extent than inner wall 55 so that the floor portion 51 slopes upwardly from outer wall 54 to inner wall 55. Lid 52 is also provided with a conduit 65 provided with a safety pressure relief valve (not shown). The conduit 65 extends through plate 53 and chamber 36 into aperture 64 and thus, in use, communicates with the interior of the oven 12. Chamber 36 is accessible through hatch 66 engaged with plate 53 and is preferably filled with an insulating material, such as particulate or powdered carbon.

A lid gasket 34 is seated on the underside portion of plate 53 external to downward extending wall 54, for sealingly engaging with a top portion 61 of upwardly extending insulating wall structure 56 of the oven 12. Lid 52 is demountably engageable with the upwardly extending insulating wall structure 56 via multiple spaced-apart mounting bolts 62 (see FIG. 1) thereby compressing lid gasket 34 between the plate 53 and top portion 61 when the oven is closed for a pyrolysis operation. The outer wall 54 of lid 52 is dimensioned to slidingly and snugly fit within inner wall 58 of the upwardly extending insulating wall structure 56 of oven 12, thereby closing the aperture 64.

As shown in FIG. 6, oven 12 is provided with multiple cooperating heating elements as exemplified by heating element pairs 38a, 38b and 38c, with heating element pair 38a being situated at the bottom of the oven 12, heating element pair 38b being situated adjacent to a side wall of oven 12 approximately at the midpoint of the height of oven 12, and heating element pair 38c being situated adjacent an upper sidewall of the oven 12. Paired heating elements 38a, 38b, and 38c are individually and collectively controllable to provide and maintain temperatures within oven 12 typically selected from the range of 100° C. to 650° C. During a pyrolysis operation, walls 54 and 58 (FIG. 5) will expand slightly and tightly abut against each other to form a good seal as the pyrolysis temperatures are reached, thereby directing the flow of pyrolysis by-products from the sides of the oven and lid toward the tubular inner wall 55 for venting into exhaust outflow pipe 40. Consequently, lid gasket 34 and mounting bolts 62 engaging lid 52 and oven 12 are spaced apart and insulated from the intense heat generated by pyrolysis taking place within oven 12, thereby significantly reducing the risk of seal failures during pyrolysis by minimizing exposure of the seal 34 to heat and also minimizing the expansion and contraction of the mounting bolts 62. To illustrate the advantage of this, it is noted that the inventors surprisingly found that, during the operation of a prototype system of the present invention, inexpensive gasket materials (in the order of $45 Canadian dollars per gasket) performed without failure for over ten pyrolysis operations, as compared to failure of expensive gasket materials (in the order of $1,000 Canadian dollars per gasket) after two or three pyrolysis operations in oven-lid configurations taught by the prior art.

As briefly noted above, and as best can be seen in FIGS. 1, 3 and 7, exhaust outflow pipe 40 allows for egress of gaseous pyrolysis by-products from oven 12 and for conveying the gaseous by-products from oven 12 to condenser 14 for cooling and separating-liquid hydrocarbon pyrolysis by-products useful as fuels from gaseous by-products exemplified by methane, ethane, butane and sulphur dioxide. Cooled liquid pyrolysis by-products are removed from the condenser 14 to a re-circulation tank 16 by piping conduit 46, while cooled gaseous pyrolysis by-products are removed from the condenser 14 by exhaust piping 44. Exhaust piping 44 is connectable to an incinerator 24 for burning off cooled gaseous pyrolysis by-products such as methane. However, it is within the scope of the present invention for exhaust piping 44 to be interconnected with diverter valves and/or gas separators and/or filters for separation, processing, collection and storage of purified cooled gaseous pyrolysis by-products in storage vessels 19, for further processing, refining and/or re-use in other applications. FIG. 1 provides a schematic diagram to illustrate to those skilled in this art, options for interconnection of filters 20, pumps 22, diverter and shut-off valves 26, blast valves 27 and gauges 50, with piping conduit 46 and incinerator 24.

Another exemplary embodiment of the present invention is illustrated in FIGS. 1, 7 and 8 showing condenser 14 wherein the liquid and gaseous pyrolysis by-products conveyed from the oven 12 are further fractionated and separated by precisely controlled air cooling. Condenser 14 comprises a first manifold 80 sealably communicating with exhaust outlet pipe 40 for receiving therein pyrolysis by-products conveyed from the oven 12. The manifold 80 is interconnected with a plurality of pipes 81 extending to and interconnected with a second manifold 85. Each pipe 81 is provided with integral external cooling fins 82 in the parts extending between manifolds 80 and 85. One end of each pipe 81 is provided with a threaded removable cap 84 for allowing access into the pipe for cleaning purposes. The second manifold 85 communicates with exhaust piping 44 extending upwardly from manifold 85 for collecting and conveying therein cooled gaseous pyrolysis by-products from condenser 14 to incinerator 24 or alternatively, to storage vessels 19. The second manifold 85 further also communicates with piping conduit 46 extending downwardly from manifold 85 for conveying cooled liquid pyrolysis by-products separated from the pyrolysis exhaust gases from the condenser 14 to the re-circulation tank 16. Alternatively, liquid pyrolysis by-products fractionated in condenser 14 may be routed into one or more holding tanks 18 via piping interconnected with pumps 22, diverter valves 26 and filters 20. Condenser 14 is provided with a plurality of spaced-apart variable-speed cooling fans 48 positioned underneath pipes 81. Precise control and regulation of cooling of the pyrolysis exhaust gases conveyed through condenser 14 thereby affecting separation, and fractionation of liquid pyrolysis by-products is provided by temperature sensors (not shown) communicating with electronic controlling devices for adjusting the speeds of cooling fans 48. While the cooling of pyrolysis exhaust gases in condenser 14 in this exemplary embodiment is provided by an air-cooling system, it is within the scope of the present invention to provide controlled cooling by other types of systems, such as liquid-based, thermoelectric based, and heat-exchange cooling systems.

A further exemplary embodiment of the present invention is illustrated in FIGS. 1, 3 and 9 wherein the exhaust outflow pipe 40 is provided adjacent to lid 52 with a pair of opposed injectors 72 interconnected with the recirculation tank 16 by injector piping 28. A portion of the cooled liquid pyrolysis by-products collected in re-circulation tank 16 is recycled by pump 22 to opposed injectors 72 that spray the liquid pyrolysis by-products at high velocity into the stream of pyrolysis gases conveyed in the exhaust outflow pipe 40 immediately after they exit oven 12. Each opposed injector 72 is interconnected into the exhaust outflow pipe 40 at an angle inclined with the direction of flow of pyrolysis gases through exhaust outflow pipe 40. Each opposed injector provides a high velocity flow of recycled liquid pyrolysis by-products in the form of a liquid laminar sheet 73 into the exhaust outflow pipe 40, wherein the laminar sheet 73 of recycled liquid pyrolysis by-products is introduced at an inclined angle to the direction of flow of pyrolysis gases through exhaust outflow pipe 40. The opposing laminar sheets 73 of recycled liquid pyrolysis by-products sprayed by injectors 72 into the exhaust outflow pipe 40 form an intersecting “V-pattern” 74 through which the pyrolysis gases must pass at the intersection, i.e., point of confluence of the two laminar sheets 73. It is preferable that each of the opposing laminar sheets 73 is injected into exhaust outlet pipe 40 at an inclined angle selected from the range of 15° to 80° with respect to the direction of flow of pyrolysis gases so that angle of the intersecting V-pattern 74 is in the range of 30° to 160′ around the flow of pyrolysis gases in exhaust outlet pipe 40. The temperature of the liquid pyrolysis by-products injected into exhaust outlet pipe 40 is preferably not allowed to exceed 55° C.

It is apparent that the injection of the cooled liquid pyrolysis by-products into the exhaust outlet pipe at an angle (having a component of movement in the direction of flow of the exhaust gas through the pipe 40) creates a large suction force, vacuum or venturi-like effect on the pyrolysis gas stream exiting oven 12, thereby significantly lowering the pressure and consequently the temperature required within the oven 12 for complete pyrolytic degradation and transformation of waster rubber. In this way, the oven may be operated at temperatures in the range of 450° C. to 650° C. as compared to conventional prior art pyrolysis systems that normally require temperatures in the range of 750° C.-900° C. or higher.

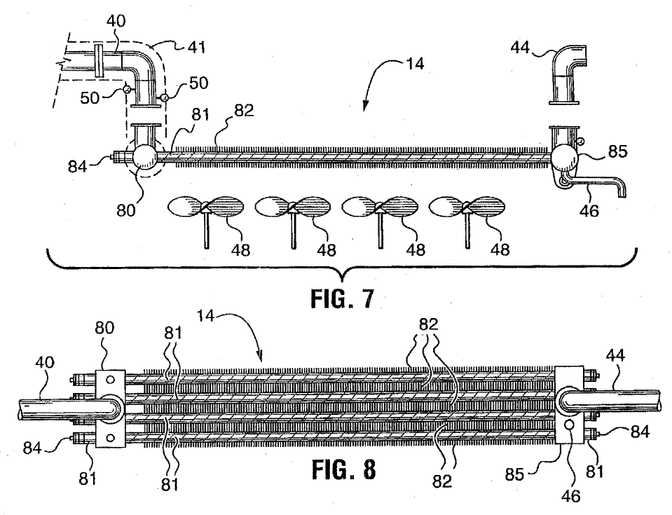

Without wishing to be bound by a particular theory of operation, this low pressure, suction or vacuum may be caused by the momentum of the cooled liquid by-products carrying along the gaseous pyrolysis products in the direction away from the oven. The V-shaped pattern may also produce a thorough mixing of the gases with the liquid and thus an efficient cooling and condensation effect. There is therefore an immediate cooling of the pyrolysis exhaust gases upon their exit from the oven 12 upon passing through the V-pattern 74 created by the two intersecting laminar sheets 73 of recycled liquid pyrolysis by-products sprayed by injectors 72 into the exhaust outflow pipe 40. The passage of gas through the sprayed liquid commences the separation of gasified liquid hydrocarbons from the gaseous pyrolysis by-products recovered from waste rubber, thereby enhancing the separation and recovery of individual pyrolysis by-products during their passage through the condenser 14. Furthermore, the immediate cooling of pyrolysis exhaust gases after their exit from oven 12 into exhaust outlet pipe 40 significantly reduces the amount of heat radiating from exhaust outlet pipe 40 into the surrounding processing facility compared to the prior art. Nevertheless, it is preferable to encase exhaust outflow pipe 40 with a pipe insulating material 41 as shown in FIG. 7.

The rubber processing apparatus 10 of the present invention can be employed for the pyrolysis and processing of waste rubber as described below.

A batch charge of waste rubber, for example comprising shredded or granulated or chipped scrapped used tires, is placed into a high-temperature resistant oven insert (not shown), which is then loaded through aperture 64 into pyrolysis oven 12. Oven 12 is then moved to and positioned under lid 52 using, for example, cart 32 moving along track 30. Lid 52 is then lowered onto oven 12 whereby outer wall 54 of chamber 36 slidingly communicates with inner wall 58 of upwardly extending insulating wall structure 58 of oven 12 until plate 53 rests on top surface 61 of insulating wall structure 58, thereby sealing against engaging lid gasket 34 situated therebetween. Lid 52 is secured to oven 12 with mounting bolts 62. The pyrolysis process is commenced by closing all valves, vents and hatches and engaging heating element pairs 38a, 38b and 38c to increase the temperature within the oven to preferably between 550° C. and 650° C., whereupon the pyrolysis reactions commence within the waste rubber loaded therein. Sensors are provided to signal a regulating device (not shown) when sufficient pyrolysis exhaust gases are generated so that a steady stream is exiting oven 12 into exhaust outlet pipe 40, whereupon the regulating device activates pump 22 interconnected with injector piping 28 interconnecting recirculation tank 16 and opposing injectors 72, thereby injecting two high velocity flows of recycled liquid pyrolysis by-products in the form of liquid laminar sheets 73 into the exhaust outflow pipe 40 The sheets 73 are inclined in the direction of flow of the pyrolysis gases through pipe 40, and thereby form an intersecting “V-pattern” 74 of liquid pyrolysis by-products through which the pyrolysis gases must pass. The liquid pyrolysis by-products can be maintained and injected at ambient temperatures which in the winter may be as low as −20° C. in northern environments and may be as high as 45° C. during the summer months. However, it is preferable to maintain the liquid pyrolysis by-product at a temperature selected from the range of 30° C. to 40° C., and injected through 50-gal nozzles set at a pressure of 5-15 p.s.i. Since the liquid pyrolysis by-products are injected into exhaust outlet pipe 40 under high pressure through injectors 72 at angles that inclined with the flow of pyrolysis gases through the pipe, the intersecting liquid laminar sheets 73 create a venturi-like effect, or put another way, a vacuum draw on the pyrolysis exhaust gases exiting oven 12. The vacuum draw significantly reduces the pressure created within oven 12 by the pyrolytic decomposition of organic materials therein, thereby reducing the amount of heat and temperature required from heating element pairs 38a, 38b, 38c to maintain and complete pyrolytic decomposition of the organic substrates. Consequently, the upper heating element pair 38c may be turned off and, as the pyrolysis process proceeds further, middle heating element pair 38b may be turned off and heat may only be provided to the oven 12 by bottom heating element pair 38a. In other words, the heat supplied by heating elements 38 to oven 12 is stepped down during the pyrolysis process, thus allowing the temperature to fall, for example, from 550° C. to 500° C. to 450° C. as each pair of heating elements 38 is shut off. The liquid pyrolysis by-products are injected into exhaust outlet pipe 40 for the duration of the pyrolysis process, thereby increasing the vacuum draw on oven 12 until the pyrolytic decomposition of organic substrate is complete, whereupon no more pyrolysis gases are drawn into exhaust outlet pipe 40 by liquid laminar sheets 73. The cessation in the flow of pyrolysis gases from oven 12 is detectable by a sensor 50 communicating with exhaust outflow pipe 40. After pyrolysis is complete, the liquid pyrolysis by-products may be injected into exhaust outlet pipe 40 for an additional period of time, preferably at least 15 minutes, to flush out particles and viscous liquids from exhaust outlet pipe 40, condenser 14 and piping conduit 46.

We have found that 3,000 lbs. of waste rubber can be completely pyrolyzed into pyrolysis by-products within an 8-hour process period, during which time the external heat supplied to the oven is stepped down twice. During the pyrolysis process, the specific types of liquid and gaseous by-products generated will be dependent on the composition of the waste rubber being pyrolyzed, and may include gases such as methane, ethane and propane which exit condenser 14 through exhaust piping 44, and may include liquids such as diesel fuel and gasoline which exit condenser 14 through piping conduit 46 and are collected separately in re-circulation tank 16 and holding tank 18, respectively. After the oven 12 has cooled to about 60° C., it is then disengaged from lid 52 and moved away from the rubber processing apparatus 10 by the cart 32 along track 30 to the central waste rubber loading area/by-product receiving/holding area where cool-down is completed. The oven insert is then removed from the oven 12 and the solid pyrolysis by-products remaining in the oven insert are removed for further processing, for example separation of particulate and powdered materials from metal i.e., metal from steel belts incorporated into tires. The particulate and powdered solid by-products can be further processed if so desired into activated carbon useful in many commercial applications. Pyrolysis of 3,000 lbs of rubber waste comprising shredded scrapped used tires with the apparatus and the batch process of the present invention produces approximately 1,200 lbs of solid by-product in the form of carbon, 1,500 lbs of diesel fuel, 150 lbs of steel, and 150 lbs of gases.

While a particular exemplary embodiment of the present invention has been described in the foregoing, it is to be understood that other embodiments are possible within the scope of the present invention and are intended to be included herein. For example, it will be clear to any person skilled in this art that the rubber processing apparatus of the present invention for processing 2,000-3,000 lbs of waste rubber is of a scale that is amenable for transportation between waste tire storage sites by permanently mounting the apparatus on a skid or pallet sized to fit onto transport or low-boy trailers, or alternatively, by mounting the apparatus directly onto transport trailers. The compact scale of the rubber processing apparatus of the present invention represents a significant savings in capital costs over those for the prior art continuous pyrolysis systems. Therefore if so desired, multiple apparatuses of the present invention may be permanently installed in a waste rubber processing facility thereby ensuring continual ongoing capacity for pyrolysis even if one apparatus is out of commission for maintenance or repairs.

In view of numerous changes and variations that will be apparent to persons skilled in the art, the scope of the present invention is to be considered limited solely by the appended claims.

1. An apparatus for separating components of waste rubber, the apparatus comprising:
at least one heating chamber for pyrolizing waste rubber contained therein, each chamber being provided with a plurality of cooperating heating elements, and each chamber comprising at least one inlet for receiving therethrough waste rubber, and at least one outlet for allowing egress therethrough of gaseous components pyrolyzed from the waste rubber;
at least one condenser for receiving therein said gaseous components and condensing at least a portion of said gaseous components to form cooled liquid components therefrom, and separating said cooled liquid components from said gaseous components;
an exhaust stack for allowing egress from the condenser of gaseous components separated from said cooled liquid components;
at least one tank for receiving therein said cooled liquid components from said condenser;
a conduit interconnecting said outlet of said chamber with said condenser, said conduit being provided with a pair of opposed injectors communicating therewith, said injectors being positioned adjacent to said outlet and inclined in the direction of flow of gaseous components through the conduit; and
at least one recirculation line provided with at least one pressurizing device, the recirculation line interconnecting said tank with said injectors for re-circulating at least a portion of said cooled liquid components for injection thereof into said conduit as intersecting liquid laminar sheets, thereby providing a vacuum draw on said gaseous components.

2. The apparatus of claim 1 wherein one injector is inclined at an angle to the flow of gaseous components, said angle selected from the range of 15° to 80° and wherein the opposing injector is inclined at the same angle.

3. The apparatus of claim 1 wherein the outlet of said heating chamber is detachably engaged with said conduit.

4. The apparatus of claim 3 wherein said heating chamber is provided with means enabling transport from said conduit to a central loading/unloading station.

5. The apparatus of claim 4 wherein the heating chamber is provided with means making said chamber transportable along a track.

6. The apparatus of claim 5 wherein the heating chamber is mounted on a cart transportable along said track.

7. The apparatus of claim 5 wherein the heating chamber is suspended below a crane mechanism transportable along the track.

8. The apparatus of claim 1 wherein the condenser is cooled by a mechanism selected from the group of air-cooling mechanisms, liquid-cooling mechanisms, thermo-electric cooling mechanisms, and heat-exchange cooling mechanisms.

9. The apparatus of claim 8 wherein the condenser comprises a first manifold communicating with a plurality of juxtaposed pipes interconnected with a second manifold, a plurality of spaced apart cooling fans mounted adjacent said pipes, the first manifold communicating with the heating chamber, the second manifold communicating with an exhaust stack for egress of cooled gaseous components therethrough, the second manifold also communicating with piping interconnected to said tank for receiving said cooled liquid components therein.

10. The apparatus of claim 9 wherein the pipes are provided with a plurality of spaced apart cooling fins.

11. An apparatus for separating components of waste rubber, the apparatus comprising:
at least one heating chamber for pyrolizing waste rubber contained therein, each chamber being provided with a plurality of cooperating heating elements, and each chamber comprising at least one inlet for receiving therethrough said waste rubber, and at least one outlet for allowing egress therethrough of gaseous components pyrolyzed from the waste rubber;
at least one condenser for receiving therein said gaseous components and condensing at least a portion of said gaseous components to form cooled liquid components therefrom, and separating said cooled liquid components from said gaseous components;
an exhaust stack for allowing egress therefrom the condenser of gaseous components separated from said liquid components; and
at least one tank for receiving therein said cooled liquid components from said condenser,
wherein said at least one inlet comprises an aperture in a wall of said heating chamber suitable for passage therethrough of said waste rubber, a doubled-walled sealable collar encircling the aperture, a corresponding detachable lid for slidingly communicating within and on said collar and for sealably engaging said heating chamber, and a gasket engaging said collar and said lid to provide a substantially air-tight seal upon positioning of said lid on and within said collar.

12. The apparatus of claim 11, further comprising:
a conduit interconnecting said outlet of said chamber with said condenser, said conduit provided with a pair of opposed injectors communicating therewith, said injectors being positioned adjacent to said outlet and inclined with the direction of flow of gaseous components through the conduit; and
at least one recirculation line provided with one or more pressurizing device(s), the recirculation line interconnecting said tank with said injectors for re-circulating at least a portion of said cooled liquid components for injection thereof into said conduit as intersecting liquid laminar sheets thereby providing a vacuum draw on said gaseous components.

13. The apparatus of claim 11 wherein the double-walled collar is filled with an insulating material.

14. The apparatus of claim 13 wherein the double-walled collar is filled with carbonaceous insulating material.

15. The apparatus of claim 11 wherein the lid comprises a mounting plate configured to seat onto said collar, said gasket being interposed between said collar and said mounting plate, In integral chamber extending from the mounting plate wherein the chamber is provided with an outer wall for slidingly communicating within said collar, the outer wall being connected with an inner wall extending through the mounting plate, wherein the inner wall comprises said outlet for egress therethrough of gaseous components pyrolyzed from the waste rubber.

16. The apparatus of claim 15 wherein the outer wall of said chamber extends below the inner wall of said chamber.

17. The apparatus of claim 15 wherein the inner wall of said chamber extends through and beyond said mounting plate.

18. The apparatus of claim 15 wherein the chamber is filled with an insulating material.

19. The apparatus of claim 18 wherein the insulating material is a carbonaceous insulating material.

20. The apparatus of claim 12 wherein one injector is inclined at an angle to the flow of gaseous components, said angle selected from the range of 15° to 80°, and wherein the opposing injector is inclined at the same angle.

21. The apparatus of claim 11 wherein said heating chamber is transportable from said detachable lid to a central loading/unloading station.

22. The apparatus of claim 21 wherein the heating chamber is transportable along a track.

23. The apparatus of claim 21 wherein the heating chamber is mountable on a cart transportable along the track.

24. The apparatus of claim 22 wherein the heating chamber is suspended below a crane mechanism transportable along the track.

25. The apparatus of claim 11 wherein the condenser is cooled by a mechanism selected from the group consisting of air-cooling mechanisms, liquid-cooling mechanisms, thermo-electric cooling mechanisms, and heat-exchange cooling mechanisms.

26. The apparatus of claim 25 wherein the condenser comprises a first manifold communicating with a plurality of juxtaposed pipes interconnected to a second manifold, a plurality of spaced apart cooling fans mounted adjacent said pipes, the first manifold communicating with the heating chamber, the second manifold communicating with an exhaust stack for egress of cooled gaseous components, the second manifold also communicating with piping interconnected with said tank.

27. The apparatus of claim 26 wherein the pipes are provided with a plurality of spaced apart cooling fins.

28. A batch process for pyrolizing waste rubber to separate and recover gaseous and cooled liquid components therefrom, said process comprising:
(h) charging a heating oven with the waste rubber;
(i) pyrolizing the waste rubber in the oven to produce a stream of gaseous components;
(j) passing said stream of gaseous components through two intersecting liquid laminar sheets of injected cooled liquid components, thereby providing a vacuum draw on said gaseous components and intermingling said gaseous components with the injected cooled liquid components;
(k) condensing said intermingled gaseous and liquid components to produce and separate cooled gas components and cooled liquid components;
(l) allowing the cooled gas components to egress through an exhaust stack for further processing;
(m) conveying the recovered cooled liquid components to a holding tank; and
(n) re-circulating at least a portion of the recovered cooled liquid components for injection into the stream of gaseous components egressing from said heating oven.

29. The batch process according to claim 28 wherein the waste rubber comprises scrapped used tires.

30. The batch process according to claim 29 wherein the scrapped used tires are processed by a method selected from the group consisting of shredding, chipping, granulating and pulverizing.

31. The batch process according to claim 28 wherein the waste rubber is pyrolyzed by first beating said oven to a temperature selected from the range of 550° C. to 650° C., maintaining said temperature until a stream of gaseous components is produced, then continuously injecting liquid components from opposing injectors into the stream of gaseous components, said liquid components maintained at a temperature selected from the range of −20° C. to 55° C., reducing the temperature within the oven to a temperature selected from the range of 500° C. to 549° C. after one third of the waste rubber has been pyrolyzed, and further reducing the temperature within the oven to a temperature selected from the range of 450° C. to 499° C. after two thirds of the waste rubber has been pyrolyzed.

32. The batch process according to claim 31 wherein the liquid components are maintained at a temperature selected from the range of 15° C. to 50° C.

33. The batch process according to claim 31 wherein the liquid components are maintained at a temperature selected from the range of 30° C. to 45° C.

34. The batch process according to claim 28 wherein the cooled gaseous components are incinerated.

35. The batch process according to claim 28 wherein the cooled gaseous components are further processed to separate and recover one or more purified gases.

36. The batch process according to claim 35 wherein the purified gases comprise the group consisting of methane, ethane and butane.

37. The batch process according to claim 28 wherein the recovered cooled liquid components are further processed by a method selected from distilling, cracking, and fractionation.
